(19) United States
(12) Patent Application Publication
(10) Pub. No.: US 2024/0178367 A1
(43) Pub. Date: May 30, 2024

(54) NEGATIVE ELECTRODE PLATE, SECONDARY BATTERY, AND ELECTRIC APPARATUS

(71) Applicant: Ningde Amperex Technology Limited, Ningde (CN)

(72) Inventors: Zhilei ZHOU, Ningde (CN); Pengyang FENG, Ningde (CN)

(73) Assignee: Ningde Amperex Technology Limited, Ningde, FJ (CN)

(21) Appl. No.: 18/522,759

(22) Filed: Nov. 29, 2023

(30) Foreign Application Priority Data
Nov. 29, 2022 (CN) 202211505013.5

(51) Int. Cl. H01M 4/133; H01M 4/36; H01M 4/587; H01M 4/66

(52) U.S. Cl. CPC H01M 4/133; H01M 4/366; H01M 4/587; H01M 4/663; H01M 4/667; H01M 2004/027

(57) ABSTRACT

A negative electrode plate includes: a negative electrode current collector; and a negative electrode active material layer that contains negative electrode active substance particles and that is disposed on at least one side of the negative electrode current collector. The negative electrode active material layer includes: a surface layer with an ID₁/IG₁ value of A, where 0.55≤A≤0.78; and a substrate layer with an ID₂/IG₂ value of B located between the negative electrode current collector and the surface layer, where 0.78≤B≤0.96. The negative electrode active material layer satisfies: 0.60≤A/B≤1.0.

### CROSS-REFERENCE TO RELATED APPLICATION

This application claims priority to Chinese Patent Application Serial No. 202211505013.5, filed on Nov. 29, 2022, the content of which is incorporated herein by reference in its entirety.

### TECHNICAL FIELD

This application relates to the field of secondary battery technologies, and in particular, to a negative electrode plate, a secondary battery, and an electric apparatus.

### BACKGROUND

In recent years, with the widespread application of secondary batteries, typically lithium-ion batteries, in energy storage systems such as power stations using hydropower, firepower, wind power, and solar power, as well as in various fields such as electric tools, electric bicycles, electric motorcycles, electric vehicles, military equipment, aerospace, and the like, higher requirements are put forward for energy density, safety, and cycling performance of the secondary batteries.

In the prior art, the selection of the negative electrode active materials in the secondary battery is relatively limited, which limits performance of the secondary battery. For example, charging and discharging efficiency of the secondary battery is reduced, cycling performance is poor, and a capacity retention rate is relatively low. Therefore, existing negative electrode active materials and negative electrode plates still need improvement.

### SUMMARY

This application provides a negative electrode plate, a secondary battery, and an electric apparatus, and is intended to improve a cycling capacity retention rate of the secondary battery and achieve a balanced kinetic performance.

A first aspect of this application provides a negative electrode plate, including:
a negative electrode current collector; and
a negative electrode active material layer that contains negative electrode active substance particles and that is disposed on at least one side of the negative electrode current collector, where the negative electrode active material layer includes a surface layer with an ID₁/IG₁ value of A and a substrate layer with an ID₂/IG₂ value of B, the substrate layer is located between the negative electrode current collector and the surface layer, and 0.55≤A≤0.78, 0.78≤B≤0.96, and 0.60≤A/B≤1.0. In the above formula, ID₁ is a peak intensity of a scatter peak of a negative electrode active substance in the surface layer at a Raman shift of 1328-1359 cm⁻¹ in a Raman spectrum, and IG₁ is a peak intensity of the scatter peak of the negative electrode active substance in the surface layer at a Raman shift of 1578-1585 cm⁻¹ in the Raman spectrum. ID₂ is a peak intensity of the scatter peak of the negative electrode active substance in the substrate layer at a Raman shift of 1328-1359 cm⁻¹ in the Raman spectrum, and IG₂ is a peak intensity of the scatter peak of the negative electrode active substance in the substrate layer at a Raman shift of 1578-1585 cm⁻¹ in the Raman spectrum.

The study found that the negative electrode active material layer formed by the negative electrode active substance particles has a surface layer and a substrate layer that satisfy the above formula, that is the ID/IG value A of the surface layer, the ID/IG value B of the substrate layer, and the ratio A/B are controlled respectively within the above ranges, a surface defect degree of the negative electrode active material layer can be controlled, which is conducive to formation of a dense and stable SEI film on a surface of the negative electrode active material layer, and in addition, the negative electrode active material layer has a improved efficiency of insertion/extraction of lithium ions, thereby improving a first Coulombic efficiency and the cycling capacity retention rate of the secondary battery, and maintaining the balanced kinetic performance.

In any embodiment of the first aspect of this application, the negative electrode active material layer satisfies: 0.70≤A/B≤0.96.

In any embodiment of the first aspect of this application, the negative electrode active material layer satisfies: 0.75≤A/B≤0.85.

In any embodiment of the first aspect of this application, a thickness of the surface layer ranges from 5 μm to 20 μm. When the thickness of the surface layer is within the above range, both preparation process costs and formation of the SEI film can be balanced, further improving the first Coulombic efficiency and the cycling capacity retention rate of the secondary battery.

In any embodiment of the first aspect of this application, a thickness of the negative electrode active material layer ranges from 30 μm to 160 μm. If the thickness of the negative electrode active material layer is excessively small, for example, smaller than 30 μm, a thin negative electrode active material layer is easy to be infiltrated by an electrolyte, and the extraction of lithium ions is easier to implement. The surface layer and the substrate layer with different ID/IG values are selected and an ID/IG ratio therebetween are controlled. In this way, improvement of performance of the secondary battery is limited. In addition, if the negative electrode active substance layer is excessively thin, a percentage of the negative electrode active material layer in the negative electrode plate decreases, thereby reducing energy density of the secondary battery. If the thickness of the negative electrode active material layer is excessively great, for example, greater than 160 μm, it is difficult for the electrolyte to infiltrate the negative electrode active substance in the middle and side reaction products caused by polarization accumulate, deteriorating the cycling performance and the kinetic performance of the secondary battery.

In any embodiment of the first aspect of this application, the negative electrode plate satisfies at least one of the following conditions:
(1) the maximum particle size of the negative electrode active substance particles is ≤55 μm;
(2) Dᵥ50 of the negative electrode active substance particles ranges from 5 μm to 15 μm; and
(3) a ratio of Dᵥ90/Dᵥ10 of the negative electrode active substance particles ranges from 1.2 to 3.2.

In any embodiment of the first aspect of this application, the negative electrode active substance includes one or more of natural graphite, artificial graphite, mesophase carbon microbeads, hard carbon, soft carbon, and carbon-silicon composite.

In any embodiment of the first aspect of this application, the negative electrode plate further includes a primer layer disposed between the negative electrode current collector and the substrate layer, and the primer layer includes a conductive agent. The primer layer containing the conductive agent is provided, so that adhesion between the negative electrode active material layer and the negative electrode current collector can be improved, so as to avoid the negative electrode active material layer from falling off from the negative electrode current collector due to repeated expansion and contraction of the negative electrode plate in a cycling process, improving shape stability of the secondary battery in the cycling process and the cycling performance and rate performance of the secondary battery.

In any embodiment of the first aspect of this application, the conductive agent includes one or more of conductive carbon black, carbon nanotubes, carbon fibers, and graphene.

In any embodiment of the first aspect of this application, a thickness of the primer layer ranges from 0.01 μm to 2 μm. If the thickness of the primer layer is excessively small, for example, smaller than 0.01 μm, coating control is difficult, and an effect of the primer layer on improving the adhesion between the negative electrode current collector and the negative electrode active material layer is not significant. If the thickness of the primer layer is excessively great, for example, greater than 2 μm, the energy density of the secondary battery is reduced because the primer layer does not provide capacity.

A second aspect of this application provides a secondary battery, including the negative electrode plate according to the first aspect.

A third aspect of this application provides an electric apparatus, including the secondary battery according to the second aspect.

According to the negative electrode plate in the embodiments of this application, the ID/IG value A of the surface layer, the ID/IG value B of the substrate layer, and the ratio A/B are controlled to 0.55≤A≤0.78, 0.78≤B≤0.96, and 0.60≤A/B≤1.0. In this way, the surface defect degree of the negative electrode active material layer in the negative electrode plate can be controlled, which is conducive to formation of the dense and stable SEI film on the surface of the negative electrode plate. In addition, the surface of the negative electrode plate has improved efficiency of insertion/extraction of lithium ions, which can ensure stability of the formed SEI film and help achieve a better balance between the first Coulombic efficiency and the cycling capacity retention rate of the secondary battery.

The above descriptions are merely an overview of the technical solutions of this application. To understand technical means of this application more clearly, and the technical means may be implemented in accordance with the contents of the specification, furthermore, to make the above and other purposes, features, and advantages of this application more comprehensible, the following embodiments of this application are specifically given as examples.

### BRIEF DESCRIPTION OF DRAWINGS

FIG. 1 is a schematic diagram of a negative electrode plate in a secondary battery according to an embodiment of this application;

FIG. 2 is a Raman spectrum of a substrate layer in a negative electrode active material layer in a negative electrode plate according to an embodiment of this application;

FIG. 3 is a schematic diagram of a negative electrode plate in a secondary battery according to another embodiment of this application;

FIG. 4 is a schematic diagram of a secondary battery according to an embodiment of this application;

FIG. 5 is an exploded view of an embodiment of a secondary battery shown in FIG. 4; and

FIG. 6 is a schematic diagram of an electric apparatus using a secondary battery according to an embodiment of this application as a power supply.

### REFERENCE SIGNS

10. a negative electrode plate; 11. a negative electrode current collector; 12. a primer layer; 13. a negative electrode active material layer; 5. a secondary battery; 51. a housing; 52. an electrode assembly; and 53. atop cover assembly.

### DETAILED DESCRIPTION

The following describes the embodiments of technical solutions of this application in detail with reference to the drawings. The following embodiments are merely intended for a clearer description of the technical solutions of this application and therefore are used as just examples which do not constitute any limitations on the protection scope of this application.

Unless otherwise defined, all technical and scientific terms used in this specification shall have the same meanings as commonly understood by those skilled in the art to which this application relates. The terms used in this specification are intended to merely describe the specific embodiments rather than to limit this application. The terms “include”, “comprise”, and any variations thereof in the specification and claims of this application as well as the foregoing brief description of drawings are intended to cover non-exclusive inclusions.

In the description of the embodiments of this application, the terms “first”, “second”, and the like are merely intended to distinguish between different objects, and shall not be understood as any indication or implication of relative importance or any implicit indication of the number, sequence or primary-secondary relationship of the technical features indicated. In the description of the embodiments of this application, the meaning of “a plurality of” is more than two, unless otherwise specifically defined.

Reference to “embodiment” in this specification means that specific features, structures, or characteristics described with reference to the embodiment may be included in at least one embodiment of this application. The word “embodiment” appearing in various places in the specification does not necessarily refer to the same embodiment or an independent or alternative embodiment that is exclusive of other embodiments. Persons skilled in the art explicitly and implicitly understand that the embodiments described in this specification may combine with another embodiment.

In the description of the embodiments of this application, the term “and/or” is only an associative relationship for describing associated objects, indicating that three relationships may be present. For example, A and/or B may indicate the following three cases: presence of only A, presence of both A and B, and presence of only B. In addition, the character “/” in this specification generally indicates an “or” relationship between contextually associated objects.

In the description of the embodiments of this specification, unless otherwise stated, “above” and “below” a number means inclusion of the number itself, and the quantity corresponding to “one or more types” and “one or more” means at least two.

The term “range” disclosed in this application is limited in a form of a lower limit and an upper limit. A given range is limited by selecting a lower limit and an upper limit, and the selected lower limit and upper limit define a boundary of a specific range. The range limited in this way may include or exclude the smaller and the largest values, and can be arbitrarily combined, that is, any lower limit may be combined with any upper limit to form a range. For example, if a range of 60 to 120 and 80 to 110 is given for a specific parameter, it may also be understood as a range of 60 to 110 and 80 to 120. In addition, if the minimum value of a range is 1 or 2, and the maximum value of the range is 3, 4, or 5, the following ranges can be defined: 1 to 3, 1 to 4, 1 to 5, 2 to 3, 2 to 4, and 2 to 5. In this application, unless otherwise specified, a numerical range “a to b” represents any combination of real numbers between a and b, and both a and b are real numbers. For example, a numerical range “0 to 5” indicates that all real numbers between “0 and 5” have been listed in this specification, and “0 to 5” is only a representation of these numerical combinations. In addition, when a parameter is described as an integer greater than or equal to 2, it means that the parameter is disclosed to be, for example, an integer of 2, 3, 4, 5, 6, 7, 8, 9, 10, 11, 12, and the like.

Dividing alternative elements or implementations disclosed in this specification into groups should not be understood as limitation. Each group member can be individually used and individually requested for protection, or in any combination with other members of the group or other elements found in this article. It may be expected that for convenience and/or purpose of patent protection, one or more members of a group may be included or removed from the group. When any such inclusion or deletion occurs, the specification is deemed to contain a modified group, thereby satisfying the written description of all Markush groups used in the claims.

It is evident to persons skilled in the art that various modifications and changes can be made in this application without departing from the protection scope of this application. Therefore, this application is intended to cover modifications and changes falling within the scope of the corresponding claims (within the claimed protection scope) and their equivalents. It should be noted that the implementations provided in the embodiments of this application can be combined with each other without contradiction.

Before the protection scope provided in the embodiments of this application is described, to facilitate the understanding of the embodiments of this application, this application first provides a specific description of the problems existing in the prior art.

With the application of lithium-ion batteries, typically secondary batteries, in various industries, requirements for performance of negative electrode plates are becoming increasingly strict. Conventional negative electrode plates cannot meet requirements for cycling performance and kinetic performance.

For example, when a secondary battery is charged for the first time, a solvent and a lithium salt around the negative electrode plate have complex reactions on a surface of the negative electrode active material layer, which contains, for example, graphite particles. The reactions form a deposited solid electrolyte interface film (hereinafter referred to as an SEI film). The solid electrolyte interface film mainly includes alkyl lithium, lithium carbonate, and lithium fluoride, etc. Generally, because the SEI film is a passivation layer, it can withstand the action of the electrolyte and separate the negative electrode active substance particles from the electrolyte, avoiding damage to the structure of the negative electrode active substance particles caused by the electrolyte.

The applicants have found that formation of the SEI film has a significant impact on performance of the secondary battery. A dense and stable SEI film can reliably protect the negative electrode active substance from erosion caused by the electrolyte, to ensure structural stability of the negative electrode active substance during a charging and discharging process of the lithium-ion battery, preventing electrochemical performance of the lithium-ion battery from deteriorating, and thus improving the cycling performance of lithium-ion batteries. In addition, the formation of the SEI film consumes lithium ions, increasing the irreversible capacity during the first charge and discharge, and reducing the first Coulombic efficiency of the lithium-ion battery. Further research has found that the formation of the SEI film is related to the surface defect degree (or a disorder degree) of the negative electrode active material. A higher surface defect degree of the negative electrode active material helps the formation of the SEI film, and also consumes more lithium ions, thereby having a certain impact on cycling performance and first Coulombic efficiency of a battery.

In view of this, this application provides a negative electrode plate, a secondary battery, and an electric apparatus. A surface defect degree of the negative electrode active material layer on a surface of the negative electrode plate can be controlled, so that formation and stability of an SEI film can be controlled. In this way, the secondary battery having the negative electrode plate has a good cycling capacity retention rate and good kinetic performance.

In this application, the secondary battery includes any apparatus in which electrochemical reactions take place to convert chemical energy and electric energy into each other. The secondary battery includes a secondary battery common in the art, such as a lithium-ion battery and a sodium-ion battery, and a specific example is a lithium secondary battery. The lithium secondary battery may includes a lithium metal secondary battery, a lithium-ion secondary battery, a lithium polymer secondary battery, or a lithium ion polymer secondary battery.

### Negative Electrode Plate

The embodiments of the first aspect of this application provide a negative electrode plate, including: a negative electrode current collector; and a negative electrode active material layer that contains negative electrode active substance particles and that is disposed on at least one side of the negative electrode current collector, where the negative electrode active material layer includes:

A surface layer with an ID₁/IG₁ value of A, where 0.55≤A≤0.78, ID₁ is a peak intensity of a scatter peak of a negative electrode active substance in the surface layer at a Raman shift of 1328-1359 cm⁻¹ in the Raman spectrum, and IG₁ is a peak intensity of the scatter peak of the negative electrode active substance in the surface layer at a Raman shift of 1578-1585 cm⁻¹ in the Raman spectrum; and

A substrate layer with an ID₂/IG₂ value of B located between the negative electrode current collector and the surface layer, where 0.78≤B≤0.96, ID₂ is a peak intensity of the scatter peak of the negative electrode active substance in the substrate layer at a Raman shift of 1328-1359 cm⁻¹ in the Raman spectrum; IG₂ is a peak intensity of the scatter peak of the negative electrode active substance in the substrate layer at a Raman shift of 1578-1585 cm⁻¹ in the Raman spectrum; and the negative electrode active material layer satisfies: 0.60≤A/B≤1.0.

According to the embodiment of this application, the negative electrode active material layer satisfies: 0.60≤A/B≤1.0. For example, the ID₁/IG₁ value of the surface layer and the ID₂/IG₂ value of the substrate layer may be 0.60, 0.65, 0.70, 0.75, 0.80, 0.85, 0.90, 0.96 or other values in a range defined by any of the above values. Because the negative electrode active material layer needs to maintain stability of an SEI film and maintain a balanced kinetic performance, usually A/B is not set to be greater than or equal to 1.

In some embodiments of this application, the negative electrode active material layer satisfies: 0.70≤A/B≤0.96. When the ratio A/B is within the above range, a better balance among the stability of the formed SEI film and the first Coulombic efficiency and the cycling capacity retention rate of the secondary battery can be achieved.

In some embodiments of this application, the negative electrode active material layer satisfies: 0.75≤A/B≤0.85. When the ratio A/B is within the above range, the best balance among the stability of the formed SEI film and the first Coulombic efficiency and the cycling capacity retention rate of the secondary battery.

In some embodiments, the surface layer has the ID₁/IG₁ value of A. The value of A ranges from 0.55 to 0.78, and may be 0.55, 0.56, 0.58, 0.62, 0.63, 0.64, 0.65, 0.66, 0.67, 0.68, 0.69, 0.70, 0.71, 0.72, 0.73, 0.74, 0.75, 0.76, 0.77, 0.78 or any other values in a range defined by any of the above values. The ID₁/IG₁ value of A of the surface layer is controlled within the above range, so that a defect degree of the surface layer can be controlled, which is conducive to efficiency of insertion/extraction of lithium ions, and also helps the formation of a dense SEI film.

In some embodiments, the substrate layer with the ID₂/IG₂ value of B is located between the negative electrode current collector and the surface layer. The value of B ranges from 0.78 to 0.96, and may be 0.78, 0.79, 0.80, 0.81, 0.82, 0.83, 0.84, 0.85, 0.86, 0.87, 0.88, 0.89, 0.90, 0.91, 0.92, 0.93, 0.94, 0.96 or any other values in a range defined by any of the above values. Controlling the substrate layer with the ID₂/IG₂ value of B is conducive to extractable capacity of the negative electrode active material and the capacity retention rate in the cycling process, and can also reduce battery polarization and irreversible capacity of the battery, and effectively control lithium precipitation.

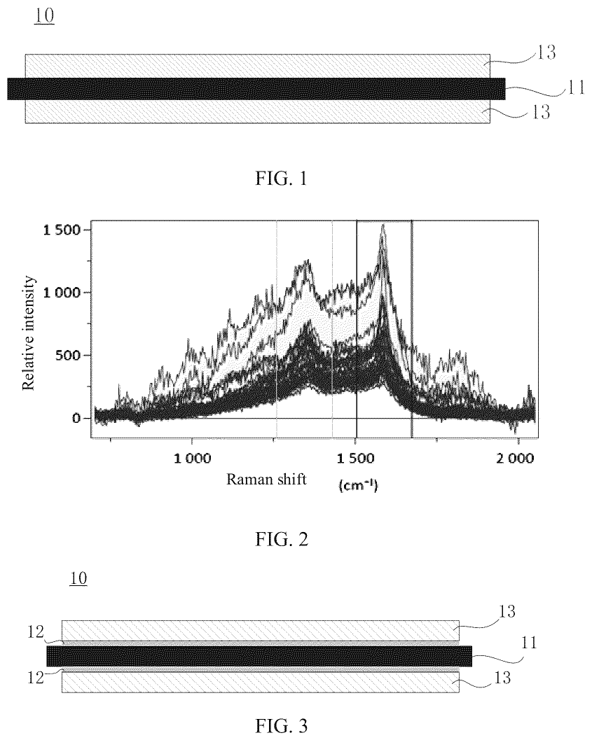

FIG. 1 is a schematic diagram of a negative electrode plate in a secondary battery according to an embodiment of this application. This example negative electrode plate 10 includes a negative electrode current collector 11 and a negative electrode active material layer 13 located on a surface of the negative electrode current collector 11.

In some embodiments, in the negative electrode plate, the negative electrode active material layer may be provided on one surface of the negative electrode current collector, or the negative electrode active material layers may be provided on two surfaces of the negative electrode current collector. This is not specifically limited in the embodiments of this application.

According to an embodiment of this application, the negative electrode current collector may be a metal foil or a porous metal plate, for example, a metal foil or a porous metal plate made of copper, nickel, titanium, iron, and other metals or an alloy thereof.

In some embodiments of this application, the negative electrode current collector may be a copper foil. In some embodiments of this application, a thickness of the negative electrode current collector may range from 4 μm to 12 μm.

It should be noted that the ID₁ value of the surface layer, the IG₁ value of the surface layer and the ID₂ value of the substrate layer, and the IG₂ value of the substrate layer can be obtained by measuring a Raman spectrum of the negative electrode active material by using well-known instruments and methods in the art. For example, a cross-section of the negative electrode active material layer is cut by using an ion polishing method, and then placed on a Raman spectrum test instrument to test the Raman spectrum of the negative electrode active material layer after focusing. For example, a Raman spectrometer is used.

The ID₁ value and the IG₁ value of the surface layer, and the ID₂ value and the IG₂ value of the substrate layer in this embodiment of this application may be measured by using a LabRAM HR Evolution laser micro Raman spectrometer. A solid-state laser with a wavelength of 523 nm may be used as a light source, with a beam diameter of 1.2 μm and power of 1 mW. A measurement mode of macroscopic Raman spectroscopy and a CCD detector are used.

FIG. 2 shows a Raman spectrum of the substrate layer. The horizontal coordinate represents a Raman shift and the vertical coordinate represents a relative intensity. The ID and IG peaks are respectively marked in the figure, and the values of ID and IG are within the above range. The intensities at the ID and IG peaks can be obtained by calculating the area of the ID and IG peaks marked in FIG. 2.

The inventors has found that when the ID₁/IG₁ value of the surface layer and the ID₂/IG₂ value of the substrate layer satisfy the above relationships, and the surface defect degree of the negative electrode active material layer is controlled within the above range, the surface defect degree of the negative electrode active material layer can be controlled, which is conducive to formation of a dense and stable SEI film on a surface of the negative electrode active material layer, and in addition, the negative electrode active material layer has improved efficiency of insertion/extraction of lithium ions, thereby improving first Coulombic efficiency and cycling capacity retention rate of the secondary battery, and maintaining a balanced kinetic performance.

Therefore, the negative electrode active material in this application is used, so that the secondary battery can simultaneously have high first Coulombic efficiency, a high cycling performance retention rate, and a high kinetic performance.

In some embodiments of this application, a thickness of the surface layer ranges from 5 μm to 20 μm. Preferably, the thickness of the surface layer may be 5 μm, 8 μm, 10 μm, 15 μm, 18 μm, and 20 μm. The thickness of the surface layer is controlled within the above range, the surface defect degree of the surface layer with the above thickness can be better controlled, thereby controlling the formation of the SEI film and further improving the first Coulombic efficiency and the cycling capacity retention rate of the secondary battery.

In some embodiments of this application, a thickness of the negative electrode active material layer ranges from 30 μm to 160 μm. Preferably, the thickness of the negative electrode active material layer may be 40 μm, 50 μm, 60 μm, 70 μm, 80 μm, 90 μm, 100 μm, 110 μm, 120 μm, 130 μm, 140 μm, 150 μm, and 160 μm.

According to some embodiments of this application, when the thickness of the negative electrode active material layer is within the above range, appropriate areal density can be implemented for the negative electrode active material layer, and in addition, the cycling capacity retention rate of the secondary battery can be ensured and a balanced kinetic performance can be further improved. Moreover, if the thickness of the negative electrode active material layer is excessively small, for example, smaller than 30 μm, a thin negative electrode active material layer is easy to be infiltrated by an electrolyte, and the extraction of lithium ions is easier to implement. The surface layer and the substrate layer with different ID/IG values are disposed on the negative electrode active material layer and an ID/IG ratio therebetween are controlled. In this way, improvement of performance of the secondary battery is limited. On the other hand, if the negative electrode active material layer is excessively thin, a percentage of the negative electrode active material layer in the negative electrode plate decreases, thereby reducing energy density of the secondary battery. If the thickness of the negative electrode active material layer is excessively great, for example, greater than 160 μm, it is difficult for the electrolyte to infiltrate the negative electrode active substance in the middle and side reaction products caused by polarization accumulate, deteriorating the cycling performance and the kinetic performance of the secondary battery.

For example, in a longitudinal section direction of the negative electrode plate, when the negative electrode active material layer is a single-layer structure, the thickness of the negative electrode active material layer may range from 30 μm to 80 μm. When the negative electrode active material layer is a double-layer structure, the thickness of the negative electrode active material layer may range from 60 μm to 160 μm.

In some embodiments of this application, the maximum particle size of the negative electrode active substance particles is <55 μm.

According to some embodiments of this application, controlling the maximum particle size of the negative electrode active substance particles helps uniformly mix the negative electrode active substance particles and allows for tight arrangement between the particles, so that compacted density of the negative electrode active material layer can be improved, thereby increasing the energy density of the secondary battery. In addition, effective capacity of the negative electrode active substance particles and kinetic performance of insertion/extraction of lithium ions can be improved.

For example, the maximum particle size of the negative electrode active substance particles can be obtained by preparing several longitudinal slices of the negative electrode plate, and the sizes of the negative electrode active substance particles in a cross-section of the longitudinal slices are counted.

In some embodiments of this application, Dᵥ50 of the negative electrode active substance particles ranges from 5 μm to 15 μm.

According to an embodiment of this application, if the Dᵥ50 of the negative electrode active substance particles is within the above range, preferably 8 μm to 12 μm, or more preferably 10 μm to 11 μm, arrangement of the particles can be more compact, so that the compacted density of the negative electrode active material layer can be improved, thereby increasing the energy density of the secondary battery. On the other hand, this can help balance the effective capacity of the negative electrode active substance particles, the kinetic performance of insertion/extraction of lithium ions, and structural stability of the particles.

In some embodiments of this application, a ratio Dᵥ90/Dᵥ10 of the negative electrode active substance particles ranges from 1.2 to 3.2.

According to an embodiment of this application, if the ratio Dᵥ90/Dᵥ10 of the negative electrode active substance particles is within the above range, preferably from 1.5 to 3.0, or more preferably from 2.0 to 2.5, the negative electrode active substance particles have good particle size distribution characteristics, so that arrangement of the negative electrode active substance particles can be more compact, helping balance the effective capacity of the negative electrode active substance particles, the kinetic performance of insertion/extraction of lithium ions, and structural stability of the particles.

The particle sizes may be measured by using the well-known instruments and methods in the art, for example, may be conveniently measured by using a laser particle size analyzer, for example, Mastersizer 2000E of Malvern Instruments, UK, according to the particle size distribution laser diffraction method GB/T 19077-2016.

In some embodiments of this application, the negative electrode active substance includes one or more of natural graphite, artificial graphite, mesophase carbon microbeads, hard carbon, soft carbon, and a carbon-silicon composite.

In some embodiments of this application, the negative electrode active substance may be natural graphite, artificial graphite, mesophase carbon microbeads, graphite coated with morphous carbon or a combination thereof, and may alternatively include at least one of hard carbon, soft carbon, and a carbon-silicon composite. According to an embodiment of this application, a dense and stable SEI film can be formed on the surface of the negative electrode active material layer, effectively protecting the negative electrode active substance from corrosion caused by the electrolyte.

In some embodiments of this application, the negative electrode active substance includes one or more of natural graphite, artificial graphite, and mesophase carbon microbeads. A degree of graphitization of the surface layer and the substrate layer can be measured separately to determine relative surface defect degrees of the surface layer and substrate layer, thereby further ensuring the first Coulombic efficiency, the cycling capacity retention rate, and the kinetic performance of the secondary battery.

In some embodiments of this application, the negative electrode plate further includes a primer layer disposed between the negative electrode current collector and the substrate layer, and the primer layer includes a conductive agent. FIG. 3 is a schematic diagram of an implementation of a negative electrode plate in another secondary battery. The example negative electrode plate 10 includes a negative electrode current collector 11, primer layers 12 located on two surfaces of the negative electrode current collector, and a negative electrode active material layer 13 located respectively on a surface of one primer layer.

According to an embodiment of this application, the primer layer is disposed between the negative electrode current collector and the substrate layer. The primer layer can improve an interface of a composite current collector, enhance adhesion between the current collector and the active substance, and ensure that the negative electrode active material layer is more firmly disposed on the surface of the current collector. In addition, this can overcome disadvantages, for example, conductivity of the composite current collector is poor and a conductive layer in the composite current collector is prone to damage. A conductive network among the current collector, the primer layer with the conductive agent, and the active substance is effectively mended and constructed, so that electron transport efficiency can be improved, and resistance between the current collector and the negative electrode active material layer can be reduced, further improving the cycling performance of the secondary battery.

In some embodiments of this application, the conductive agent includes one or more of conductive carbon black, carbon nanotubes, carbon fibers, and graphene.

According to this embodiment, the foregoing conductive agent is provided in the primer layer, which can further improve conductivity of the primer layer, reduce the resistance between the negative electrode active material layer and the current collector, thereby reducing electrode polarization. In addition, mechanical properties of the primer layer can be improved, further increasing an adhesive strength between the current collector and the negative electrode active material layer.

In some embodiments of this application, a thickness of the primer layer ranges from 0.01 μm to 2 μm. Preferably, the thickness of the primer layer may be 0.1 μm, 0.2 μm, 0.3 μm, 0.4 μm, 0.5 μm, 1 μm, 1.5 μm, and 2 μm. The thickness of the primer layer is within the above range, which is conducive to ensuring a total thickness of the primer layer and the negative electrode active material layer, controlling the thickness of the negative electrode active material layer in an appropriate range, and promoting the cycling performance of the negative electrode plate. This is conducive to ensuring an adhesive strength between the current collector and the negative electrode active material layer, while the energy density is not significantly reduced.

In some embodiments of this application, the negative electrode active material layer includes a first negative electrode active material layer and a second negative electrode active material layer. The first negative electrode active material layer is disposed on at least one surface of the negative electrode current collector, and the second negative electrode active material layer is disposed on a surface of the first negative electrode active material layer facing away from the negative electrode current collector. In the second negative electrode active material layer, the negative electrode active substance contains graphite coated with amorphous carbon.

In the foregoing embodiments, the negative electrode active material layer includes the first negative electrode active material layer and the second negative electrode active material layer, and the first negative electrode active material layer is disposed on at least one surface of the negative electrode current collector, while the second negative electrode active material layer is disposed on a surface of the first negative electrode active material layer facing away from the negative electrode current collector. Bilayered active material layers may be conducive to improving the kinetic performance of the secondary battery.

In the first negative electrode active material layer, the negative electrode active substance may be one or more of natural graphite, artificial graphite, mesophase carbon microbeads, hard carbon, soft carbon, and a carbon-silicon composite. A material selected from the above materials is conducive to improving the energy density of the secondary battery.

In the second negative electrode active material layer, the negative electrode active substance may be one or more of natural graphite, artificial graphite, mesophase carbon microbeads, hard carbon, soft carbon, a carbon-silicon composite, and graphite coated with amorphous carbon, which is further conducive to improving the kinetic performance of the secondary battery. Another material well known in the art can alternatively be used.

In some embodiments of this application, the negative electrode active material layer further includes a binder. The binder may be selected from one or more of styrene butadiene rubber (SBR), polyacrylic acid (PAA), sodium polyacrylate (PAAS), polyacrylamide (PAM), polyvinyl alcohol (PVA), sodium alginate (SA), polymethacrylic acid (PMAA), and carboxymethyl chitosan (CMCS).

In some embodiments of this application, the negative electrode active material layer further includes a conductive agent. The conductive agent may be selected from at least one of superconducting carbon, acetylene black, carbon black, Ketjen black, carbon dots, carbon nanotubes, graphene, and carbon nanofibers.

In some embodiments of this application, the negative electrode active material layer may further include other additives, for example, a thickener (for example, sodium carboxymethyl cellulose (CMC-Na)) and the like.

However, this application is not limited to the foregoing materials. The negative electrode plate in this application can also use other well-known materials that can be used as a negative electrode active material, a conductive agent, a binder, and a thickener.

The negative electrode plate in this application may be prepared according to a conventional method in the art. For example, the negative electrode active material, the conductive agent, the binder, and the thickener are dispersed in a solvent to obtain a uniform negative electrode slurry, where the solvent may be N-methylpyrrolidone (NMP) or deionized water. The negative electrode slurry is applied onto the negative electrode current collector and undergoes drying and cold pressing to obtain the negative electrode active material layer and then the negative electrode plate.

### Secondary Battery

The embodiment of the second aspect of this application provides a secondary battery, including the negative electrode plate according to the first aspect of this application.

As described above, in this application, the secondary battery includes any apparatus that generates electrochemical reaction to convert chemical energy and electric energy into each other. The secondary batteries include common secondary battery in the art, such as lithium ion batteries and sodium-ion batteries. Specific examples are lithium secondary batteries, and the lithium secondary batteries may include lithium metal secondary batteries, lithium ion secondary batteries, lithium polymer secondary batteries, or lithium ion polymer secondary batteries.

Specifically, according to an embodiment of this application, the secondary battery includes an electrode assembly and an electrolyte. The electrode assembly includes a negative electrode plate, a positive electrode plate, and a separator disposed between the negative electrode plate and the positive electrode plate according to the first aspect of this application.

The embodiments of the negative electrode plate have been described and explained in detail above, and will not be repeated herein. It may be understood that the secondary battery according to the second aspect of this application can achieve beneficial effects of any of the foregoing embodiments of the negative electrode plate of this application.

In an embodiment of this application, the positive electrode plate includes a positive electrode current collector and a positive electrode active material layer that contains a positive electrode active material and that is disposed on at least one surface of the positive electrode current collector.

It may be understood that the positive electrode plate may be provided with a positive electrode active material layer on one surface of the positive electrode current collector, or with the positive electrode active material layers on two surfaces of the positive electrode current collector. This is not limited in the embodiments of this application.

The positive electrode current collector may be a metal foil or a porous metal plate, for example, a metal foil or porous metal plate made of aluminium, copper, nickel, titanium, iron, and other metals or an alloy thereof. In some embodiments of this application, the positive electrode current collector may be an aluminum foil.

In some embodiments of this application, the positive electrode active material may be selected from one or more of olivine-structured materials such as lithium manganese iron phosphate, lithium iron phosphate, and lithium manganese phosphate, ternary structural materials such as NCM811, NCM622, NCM523, and NCM333, or lithium cobalate materials, lithium manganate materials, and other metal oxides capable of inserting and extracting lithium.

In some embodiments of this application, the positive electrode active material layer further includes a binder. The binder enhances cohesion strength between particles of the positive electrode active material, and cohesion strength between the positive electrode active material and the current collector. For example, the binder may be selected from at least one of polyvinyl alcohol, hydroxypropyl cellulose, diacetyl cellulose, polyvinyl chloride, carboxylated polyvinyl chloride, polyvinyl fluoride, polymers containing ethylene oxide, polyvinyl pyrrolidone, polyurethane, polytetrafluoroethylene, polyvinylidene-1-difluoroethylen, polyethylene, polypropylene, styrene-butadiene rubber, acrylic styrene-butadiene rubber, epoxy resin, nylon, and the like.

In some embodiments of this application, the positive electrode active material layer further includes a conductive agent. The conductive agent is selected from at least one of a carbon-based material, a metal-based material, a conductive polymer, and a mixture thereof. For example, the carbon-based material is selected from carbon black, acetylene black, Ketjen black, carbon fiber, carbon nanotubes, or any combination thereof. The metal-based material is selected from metal powder, metal fiber, copper, nickel, aluminum, or silver. The conductive polymer is a polyphenylene derivative.

The positive electrode plate in this application may be prepared using a conventional method in the art. For example, the active material, the conductive agent, and the binder are dispersed in N-methylpyrrolidone (NMP) to obtain a uniform positive electrode slurry. The positive electrode slurry is applied on the positive electrode current collector and undergoes processes such as drying, cold pressing, cutting, slitting, and re-drying to obtain the positive electrode plate.

In an embodiment of this application, the separator may be polyethylene, polypropylene, polyvinylidene fluoride, or multilayer composite films thereof.

In some embodiments of this application, the separator is a single-layer separator or a multi-layer separator.

A shape and a thickness of the separator are not specifically limited in the embodiments of this application. A preparation method of the separator is a well-known method in the art that may be used for the preparation of a separator of a secondary battery.

In the embodiments of the secondary battery in this application, the electrolyte is a carrier for transporting ions and can play a role in transporting ions between the positive electrode plate and the negative electrode plate, ensuring advantages, for example, the secondary battery achieves good cycling performance.

In an embodiment of this application, the electrolyte includes propylene carbonate (PC for short) and fluoroethylene carbonate (FEC for short). The propylene carbonate and the fluoroethylene carbonate can have a synergistic effect, which is conducive to forming a stable SEI film on a surface of the negative electrode plate, improving high temperature storage performance and high temperature cycling performance of the secondary battery.

In an embodiment of this application, on the premise of ensuring the high temperature cycling performance of the secondary battery, it is also necessary to improve the charging and discharging performance of the secondary battery. Therefore, the electrolyte further includes a lithium salt. A specific material of the lithium salt is not limited in the embodiments of this application and may be a lithium salt commonly used in the art. For example, the lithium salt may be selected from at least one of lithium hexafluorophosphate, lithium tetrafluoroborate, lithium difluorosulfimide, lithium bis borate, and lithium difluoromethylborate.

The electrolyte may be prepared using a conventional method in the art. For example, an organic solvent, a lithium salt, and an optional additive may be mixed to uniformity to obtain an electrolyte. An order in which each material is added is not limited.

The secondary battery in this application may be prepared using a conventional method in the art. For example, the positive electrode plate, the separator, and the negative electrode plate are stacked in sequence, so that the separator is located between the positive electrode plate and the negative electrode plate. Then, the positive electrode plate, the separator, and the negative electrode plate are wound to obtain the electrode assembly. The electrode assembly is put in a housing, and the electrolyte is injected, followed by vacuum packaging, standing, formation, vacuum molding, and other processes to obtain the secondary battery.

The housing may be a hard shell housing or a flexible housing. For example, the hard shell housing may be metal. The flexible housing may be a metal plastic film, for example, aluminum plastic film, and a steel plastic film.

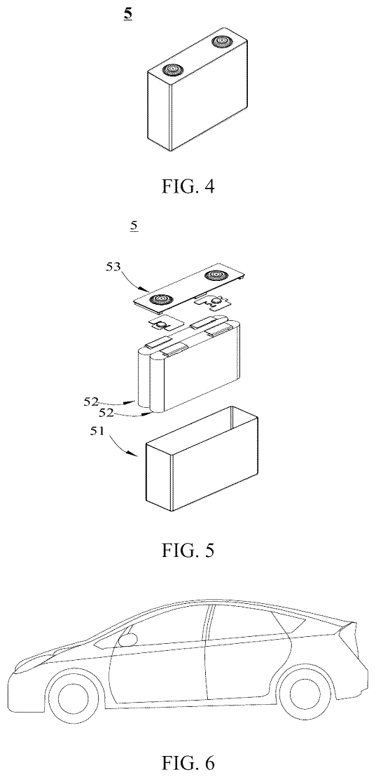

This application does not impose special limitations on a shape of the secondary battery, and the secondary battery may be cylindrical, rectangular, or any other shapes. For example, FIG. 4 shows a rectangular secondary battery 5 as an example.

In some embodiments of this application, referring to FIG. 5, an outer package may include a housing 51 and a top cover assembly 53. The housing 51 may include a bottom plate and side plates connected to the bottom plate, and the bottom plate and side plates enclose an accommodating cavity. The housing 51 has an opening in communication with the accommodating cavity, and the top cover assembly 53 can cover the opening to close the accommodating cavity. The positive electrode plate, the negative electrode plate, and the separator may be wound or laminated to form an electrode assembly 52. The electrode assembly 52 is encapsulated in the accommodating cavity. The electrolyte infiltrates the electrode assembly 52. There may be one or more electrode assemblies 52 in the secondary battery 5, and may be selected by persons skilled in the art based on an actual need.

The secondary battery in this application includes the negative electrode plate in the first aspect of this application, which can also achieve beneficial effects of various implementations of the negative electrode plate in this application.

### Electric Apparatus

Another aspect of this application provides an electric apparatus, and the electric apparatus includes the secondary battery provided in this application. The secondary battery provided in this application has good cycling capacity retention rate and balanced kinetic performance, so that the electric apparatus provided in this application has good cycling capacity retention rate and balanced kinetic performance.

The electric apparatus is not particularly limited in the embodiments of this application, and may be any known electric apparatus applicable in the prior art. In some embodiments of this application, the electric apparatus may include, but is not limited to, notebook computers, pen-input computers, mobile computers, e-book players, portable phones, portable fax machines, portable copiers, portable printers, head-mounted stereo headsets, video recorders, liquid crystal display televisions, portable cleaners, portable CD players, mini discs, transceivers, electronic notebooks, calculators, memory cards, portable recorders, radios, backup power supplies, motors, automobiles, motorcycles, assisted bicycles, bicycles, lighting apparatuses, toys, game machines, clocks, electric tools, flashlights, cameras, large household storage batteries, or lithium-ion capacitors.

FIG. 6 shows an electric apparatus as an example. The electric apparatus is a battery electric vehicle, a hybrid electric vehicle, a plug-in hybrid electric vehicle, or the like.

The electric apparatus using a secondary battery in this application includes the negative electrode plate according to the first aspect of this application, which can also achieve beneficial effects of various implementations of the negative electrode plate according to this application.

### EXAMPLES

The following examples describe in more detail content disclosed in this application. These examples are intended only for illustrative purposes because various modifications and changes made without departing from the scope of the content disclosed in this application are apparent to persons skilled in the art. Unless otherwise stated, all parts, percentages, and ratios reported in the following examples are based on weights, all reagents used in the examples are commercially available or synthesized in a conventional manner, and can be used directly without further processing, and all instruments used in the examples are commercially available.

For easy of description, in the following examples, the secondary battery being a lithium-ion secondary battery is used as an example to describe in detail the secondary battery and manufacturing method thereof.

### Examples 1 to 4

### (1) Preparation of Positive Electrode

A positive electrode active material lithium cobalt oxide (LiCoO₂), a conductive agent (acetylene black), and a binder polyvinylidene fluoride (PVDF for short) were thoroughly stirred in a solvent N-methylpyrrolidone (NMP for short) at a mass ratio of approximately 97.6:1.2:1.2, to obtain a positive electrode slurry; and then the positive electrode slurry was applied onto a positive electrode current collector aluminum foil, followed by drying, cold pressing, cutting, slitting, and re-drying, to obtain a positive electrode plate.

### (2) Preparation of Negative Electrode

Preparation of a negative electrode plate (double-layer coating): unmodified graphite with different particle sizes was selected as a negative electrode active material. ID/IG values were adjusted according to the different particle sizes of the negative electrode active material. The graphite with different particle sizes was dispersed in a solvent deionized water, and then stirred and mixed fully with a binder styrene butadiene rubber (SBR) and a thickener sodium carboxymethyl cellulose (CMC) at a mass ratio of 97.7:1.2:1.1, to obtain different negative electrode active slurries; and the different negative electrode active slurries were applied onto a negative electrode current collector copper foil. A method of double-layer coating was selected to control a surface defect degree of the negative electrode active material layer. A sample at a lower layer was tested to determine that a coating weight satisfies a designed standard value. An upper layer continues to be applied with the slurry, and a sample at the upper layer was test to determine that a coating weight of two layers satisfy the designed standard value. The double-sided coating was performed by continuing such operation. Then, the negative electrode plate of the present invention was obtained by roll pressing. A value A, a value B, and a value A/B for the prepared negative electrode plate are shown in Table 1.

### (3) Preparation of Separator

A 7 μm-thick polyethylene (PE) porous polymer film was used as a separator.

### (4) Preparation of Electrolyte

In an argon atmosphere glove box with a water content <10 ppm, ethylene carbonate (EC), propylene carbonate (PC), and diethyl carbonate (DEC) were mixed (at a mass ratio of approximately 1:1:1), and a lithium salt LiPF₆ was added and mixed to uniformity. Concentration of the LiPF₆ is 1.15 mol/L. Based on the total weight of the electrolyte, an appropriate amount of fluoroethylene carbonate (FEC) was added into the electrolyte.

### (5) Preparation of Lithium-Ion Battery

A positive electrode plate, a separator, and a negative electrode plate were stacked in sequence, so that the separator was provided between the positive electrode plate and the negative electrode plate for separation. Then they were wound to obtain a bare cell. After tabs were welded, the bare cell is placed in an outer package of aluminum-foil plastic film, followed by drying, and then the prepared electrolyte was injected into the dried bare cell. The wound bare cell was placed in the outer package, and the electrolyte was injected and packaged. After forming, degassing, trimming, and other processes, a lithium-ion battery was obtained. Lithium-ion batteries in examples and comparative examples of this application were all prepared according to the foregoing method.

### Examples 5 to 9

The preparation method was similar to that of example 1, except that in the preparation of the negative electrode material, natural graphite ore was selected for crushing/ball milling/flotation to obtain natural flake graphite, and the flake graphite was optimized based on a shape, a cross-section, hardness, and a particle size of the flake graphite, followed by processing using a chelating agent and a pickling agent, to obtain high-purity graphite. Next, a series of surface modifications were carried out on the high-purity graphite, mainly using powder asphalt or other polymer substances mixed with high-purity graphite powder. A powder mixing device was used as a mixing device with an isostatic pressing device to mix the high-purity graphite and a modifier at a ratio of 1:1 to 7:3. Then, graphitization was performed on the mixture at a temperature of 2500-3300° C. After graphitization, surface modification was performed on the graphite again using a modifier high-purity asphalt with a softening point of 100° C. to 350° C., and the graphite and the modifier was used at a ratio of 80:20 to 99:1. After that, the modified graphite was carbonized at a temperature of 800° C. to 1500° C. The ID/IG values of different negative electrode active materials are controlled by controlling the degree of surface coating of the negative electrode active substances. A value A, a value B, and a value A/B for the prepared negative electrode plate are shown in Table 1. The particle size of the negative electrode active substance particles in example 6 is shown in Table 2.

### Example 10

The preparation method is similar to that of example 1, except that in the preparation of the negative electrode plate (single-layer coating): the negative electrode active substance, the binder styrene-butadiene rubber (SBR), and the thickener sodium carboxymethyl cellulose (CMC) were dispersed in a solvent deionized water and fully stirred and mixed at a mass ratio of 97.7:1.2:1.1, and then were applied onto the negative electrode current collector copper foil pre-coated with a conductive coating. A rolling process was performed three times in a roll pressing process, and the difference in thickness between the second rolling and the third rolling was controlled within 5 μm to 20 μm, and the two rolling were performed 12 hours to 24 hours apart, and the surface defect degree of the negative electrode active material layer was controlled by using the roll pressing process. A value A, a value B, and a value A/B for the prepared negative electrode plate are shown in Table 1.

### Examples 11 to 23

The preparation method was the same as that of example 6, except that the particle size of the negative electrode active substance particles was different, as shown in Table 2.

### Examples 24 to 33

The preparation method was the same as that of example 16, except that the particle size of the negative electrode active substance particles in the negative electrode plate was different, and the thickness of the negative electrode active material layer, the thickness of the copper foil, the type and thickness of the primer layer were different, as specifically shown in Table 3.

### Comparative Example 1

The preparation method was similar to that of example 6, except that a different ratio of the surface modification materials was used for different substrate layers and surface layers, as specifically shown in Table 1.

### Comparative Example 2

The preparation method was the same as that of example 6, except that the same negative electrode active substance was used for the substrate layer and the surface layer, as shown in Table 1.

### Tests

### (1) Direct Current Resistance (DCR) Test

A lithium-ion battery was charged to 4.48 V at a constant current of 1.5 C, and then charged to 0.05 C at a constant voltage; left standing for 30 min; discharged at a constant current of 0.1 C for 10 s (a corresponding voltage U1 was recorded every 0.1 s), and discharged at a constant current of 1 C for 360 s (a corresponding voltage U2 was recorded every 0.1 s). The charging and discharging were repeated 5 times. “1 C” means a current at which the battery capacity is fully discharged within 1 hour, and “0.1 C” means a current at which the battery capacity is fully discharged within 110 hours.

DCR was calculated by using the following formula: R=(U2−U1)/(1 C−0.1 C). The DCR in this application was a value at 50% SOC (state of charge).

### (2) 45° C. Cycling Test

The tested battery was left standing for 5 min at a test temperature of 45° C. The lithium-ion battery was charged to 4.48 V at a constant current of 1.5 C; charged to 0.05 C at a constant voltage of 4.48 V; left standing for 5 min; discharged to 3.0 V at a constant current of 1.0 C; and left standing for 5 min. At this point, the capacity was recorded as DO. The above charging and discharging process was repeated 500 times, and the last discharge capacity was recorded as D1. After the cycling at 45° C. finished, a capacity decay rate was D1/D0.

### (3) Volumetric Energy Density (VED)

The tested battery cell was charged to 4.48 V at a current of 1.5 C at room temperature; charged to 0.05 C at a constant voltage of 4.48 V; left standing for 5 min; discharged to 3.0 V at a constant current of 0.025 C; and left standing for 5 min. At this point, the capacity was recorded as D in a unit of mAh. Then the battery cell was charged to 4.0 V at 1.0 C. At this point, a length, a width, and a thickness of the battery cell were measured, to calculate a volume V of the battery cell in a unit of mm³. The volumetric energy density was calculated by using a formula: VED=(D×3.89×1000)/V in a unit of Wh/L.

### (4) Raman Spectrum Analysis

The LabRAM HR Evolution laser micro Raman spectrometer was used to determine the negative electrode active materials in various examples and comparative examples. A solid-state laser with a wavelength of 523 nm was used as a light source, with a beam diameter of 1.2 μm and power of 1 mW. A measurement mode of macroscopic Raman spectroscopy and a CCD detector were used.

Negative electrode active material powders were pressed into a plate. 3 points were randomly selected on the plate for testing to obtain an average based on the three measurement values.

The value A and the value B only differ because they were taken at different positions or regions. Using A as an example, a negative electrode plate fully discharged (0% SOC) was selected after being disassembled, and processed by using an IB-09010 ion polisher to obtain a cross-section of the negative electrode plate. Then a sample of the cross-section was transferred to an objective stage of the HR Evolution Raman spectrometer for performing Raman analysis. Areas of the cross-section on the surface layer and the substrate layer were selected for random box selection to analyze their ID/IG values. 5 parallel samples were tested and 20 photos of each parallel sample were selected. An average value of the ID₁/IG₁ values of the surface layer was calculated and denoted as A. An average value of the ID₂/IG₂ values of the substrate layer was calculated and denoted as B. The surface layer has the ID₁/IG₁ value of A. The value of A ranges from 0.55 to 0.78, and the value of B ranges from 0.78 to 0.96.

According to the foregoing preparation method, example 1 to 10 were obtained. Effects of the ID₁/IG₁ value A of the surface layer, the ID₂/IG₂ value B of the substrate layer, a ratio A/B, and different ratios of graphite to modifier in double-layer coating on cycling performance and DCR performance of the lithium-ion battery are shown in Table 1.

TABLE 1
Preparation parameters and battery test data of
negative electrode plate corresponding to examples
1 to 10 and comparative examples 1 and 2

| | | | | Cycling | |
|---|---|---|---|---|---|
| | | | | capacity | |
| | | | | retention rate | DCR |
| Serial number | A | B | A/B | % (500 cycles) | (mΩ) |
| Example 1 | 0.55 | 0.92 | 0.60 | 76 | 128 |
| Example 2 | 0.78 | 0.95 | 0.82 | 69 | 115 |
| Example 3 | 0.65 | 0.93 | 0.70 | 71 | 120 |
| Example 4 | 0.71 | 0.84 | 0.85 | 68 | 115 |
| Example 5 | 0.72 | 0.96 | 0.75 | 67 | 115 |
| Example 6 | 0.73 | 0.82 | 0.89 | 72 | 118 |
| Example 7 | 0.75 | 0.81 | 0.93 | 71 | 120 |
| Example 8 | 0.76 | 0.79 | 0.96 | 70 | 121 |
| Example 9 | 0.77 | 0.79 | 0.98 | 66 | 130 |
| Example 10 | 0.78 | 0.87 | 0.90 | 67 | 122 |
| Comparative | 0.55 | 0.90 | 0.6 | 60 | 150 |
| Example 1 | | | | | |
| Comparative | 0.78 | 0.78 | 1.0 | 50 | 160 |
| Example 2 | | | | | |

In Table 1:

ID₁ is a peak intensity of a scatter peak of a negative electrode active substance in the surface layer at a Raman shift of 1328-1359 cm⁻¹, and IG₁ is a peak intensity of the scatter peak of the negative electrode active substance in the surface layer at a Raman shift of 1578-1585 cm⁻¹.

ID₂ is a peak intensity of the scatter peak of the negative electrode active substance in the substrate layer at a Raman shift of 1328-1359 cm⁻¹, and IG₂ is a peak intensity of the scatter peak of the negative electrode active substance in the substrate layer at a Raman shift of 1578-1585 cm⁻¹.

As shown in Table 1, according to example 1, example 3, and example 5, it can be learned that as the ID₁/IG₁ value A of the surface layer, the ID₂/IG₂ value B of the substrate layer, and the ratio A/B all increase, the cycling capacity retention rate shows a gradually decreasing trend, and the DCR gradually decreases. The reason is that when defects increase, electrochemical reaction sites of lithium ions increase, channels for insertion and extraction of lithium increase, and polarization is reduced, resulting in a decrease in impedance and an improvement in kinetics. However, in addition, active sites increase, so that consumption of active lithium required for film formation also increases, thus affecting the capacity retention rate after cycling.

In examples 1 to 4 of Table 1, an upper layer and a lower layer of the double-layer coating are coated with graphite particles of different particle sizes. Typically, if the particle size is smaller, graphitization is harder and there are more surface defects. That is, the ID/IG values of different negative electrode active layers can be controlled by controlling different graphite particle sizes. From examples 1 to 4, it can be learned that when the ratio A/B is controlled within a range required by this application, a balance between the cycling capacity retention rate and DCR performance can be achieved.

In examples 5 to 9 of Table 1, the upper layer and the lower layer of the double-layer coating are coated with graphite with different coating ratios. When the ratio of graphite to modifier decreases, the value A increases, and the value A/B also increases. This happens because as an amount of the modifier increases, the modifier after carbonization mainly has a soft carbon structure. Therefore, there are more defects, leading to an increase in the defects of the surface layer of the negative electrode active material layer. In other words, the ID/IG values of different negative electrode active material layers can be adjusted by using different degrees of modification on the graphite surface. For the kinetic performance of the lithium-ion battery, the main bottleneck is that porosity is small and impedance is large because a surface of the electrode plate is subject to pressure, which leads to a decrease in kinetics. If the defect degree of the surface layer can be improved, the kinetics at this area can be improved, thereby improving overall kinetic performance.

In example 10 of Table 1, different ID/IG values for the upper layer and the lower layer can be obtained by controlling the thickness difference between the second rolling process and the third rolling process after single-layer coating.

Data in comparative example 1 shows that the graphite used for the upper layer is unmodified by a modifier. A polarization surface with high compacted density is close to a closed pore state. Therefore, overall kinetic performance is poor. In addition, due to the increase in polarization in the cycling process, the consumption of active lithium ions by the SEI increases, leading to a deterioration in the cycling capacity retention rate.

Data of comparative example 2 shows that the negative electrode coated with the same active substance on the upper layer and the lower layer has significantly lower cycling capacity retention rate and DCR compared to example 1 to 10.

It can be learned from data in Table 1 that the negative electrode plate in this application includes a negative electrode current collector; and a negative electrode active material layer that contains negative electrode active substance particles and that is disposed on at least one side of the negative electrode current collector. The negative electrode active material layer includes a surface layer with an ID₁/IG₁ value of A, where the value A ranges from 0.55 to 0.78; and a substrate layer with an ID₂/IG₂ value of B located between the negative electrode current collector and the surface layer, where the value B ranges from 0.78 to 0.96. In this way, the negative electrode plate in this application has high first Coulombic efficiency and cycle life. Especially when the Raman spectrum of the negative electrode active material layer satisfies: 0.60≤A/B≤1.0, the cycling capacity retention rate of the negative electrode active material can be further improved. The negative electrode plate in this application can reduce the DCR and improve the cycling capacity retention rate. In addition, when 0.70≤A/B≤0.96, the formation of the SEI film is more stable, and a good balance between the cycling capacity retention rate and the DCR can be achieved. When 0.75≤A/B≤0.85, both the cycling capacity retention rate and the DCR of the battery can achieve the best performance.

Further, according to the foregoing preparation method, example 11 to 23 were obtained. Effects of the Dᵥ50, the Dᵥ90/Dᵥ10 of the negative electrode active substance particles, as well as the maximum diameter on a longitudinal section of the particles on the cycling capacity retention rate and the direct current resistance (DCR) of the lithium-ion battery are shown in Table 2.

The particle size may be conveniently measured by using a laser particle size analyzer (for example, Mastersizer 2000E of Malve Instruments, UK) according to the particle size distribution laser diffraction method GB/T 19077-2016.

TABLE 2
The particle size of negative electrode active substance particles
and battery test data corresponding to examples 11 to 23

| | | | | Cycling | |
|---|---|---|---|---|---|
| | | | Maximum | capacity | |
| Serial | Dᵥ50/ | Dᵥ90/ | particle | retention rate | DCR |
| number | μm | Dᵥ10 | diameter/μm | % (500 cycles) | (mΩ) |
| Example 6 | 16 | 3.3 | 56 | 72.0 | 118 |
| Example 11 | 5.0 | 3.2 | 30 | 78.0 | 94 |
| Example 12 | 6.0 | 3.0 | 33 | 80.0 | 95 |
| Example 13 | 7.0 | 2.8 | 36 | 80.5 | 96 |
| Example 14 | 8.0 | 2.6 | 39 | 81.0 | 97 |
| Example 15 | 9.0 | 2.4 | 42 | 81.3 | 98 |
| Example 16 | 10.0 | 2.2 | 45 | 82.5 | 98 |
| Example 17 | 11.0 | 2.0 | 46 | 82.5 | 100 |
| Example 18 | 12.0 | 1.8 | 49 | 83.0 | 101 |
| Example 19 | 13.0 | 1.6 | 51 | 83.5 | 102 |
| Example 20 | 14.0 | 1.4 | 53 | 84.0 | 103 |
| Example 21 | 15.0 | 1.2 | 55 | 84.5 | 105 |
| Example 22 | 4.5 | 1.1 | 20 | 68.0 | 120 |
| Example 23 | 20 | 3.5 | 58 | 80 | 130 |

As shown in Table 2, based on example 6 of Table 1, effects of graphite types and particle sizes of negative electrode active substances on cycling and DCR of a lithium-ion battery are further investigated.

According to examples 11 to 21, as Dᵥ50 gradually increases, the maximum diameter of the particles also increases. Through particle size screening, grading, and control, a value of Dᵥ90/Dᵥ10 also further decreases. In this case, the cycling capacity retention rate gradually increases, while the direct current resistance DCR gradually increases. This happens because if the particle size Dᵥ50 in a longitudinal direction increases, pores of the electrode plate decreases and consumption of active lithium ions acting on the SEI film decreases, resulting in an increase in the cycling capacity retention rate. If the particle size increases, diffusion paths of lithium ions increase. Therefore, direct current resistance of the lithium ions increases and the kinetics deteriorates.

According to example 22, it can be learned that when the Dᵥ50 decreases to 4.5 μm, the maximum diameter of the particles is reduced to 20 μm. In this case, the particle size is excessively small. In a crushing process of the particles, surfaces of the particles crush and new surfaces emerge, which may result in new defects. Therefore, compared to examples 16 to 21, the cycling retention rate is significantly reduced, while because side reaction products accumulate, the DCR also increases.

According to example 23, when the Dᵥ50 increases to 20 μm, the maximum diameter of the particles increases to 58 μm. In this case, the particle size is excessively large, a transport path of lithium ions inside the particles becomes longer. Therefore, in the cycling process, electrochemical polarization increases, manifested as an increase in DCR impedance. In this case, if the particle size is excessively large, it is easy to scratch the current collector in the preparation process, causing safety issues.

Further, according to the foregoing preparation method, examples 24 to 33 were obtained. Effects of the thickness of the negative electrode active material layer, the thickness of the copper foil, the type and thickness of the primer layer on performance of the volumetric energy density (VED), the cycling capacity retention rate, and the direct current resistance of the lithium-ion battery are shown in Table 3.

TABLE 3
The thickness of the negative electrode active material layer, the
thickness of the copper foil, the type and thickness of the primer layer, and
battery test data corresponding to examples 23 to 32

| | | | | | | | Cycling | |
|---|---|---|---|---|---|---|---|---|
| | | | | | | | capacity | |
| | | | | | | | retention | |
| | | | Thickness | Thickness | | | rate % | |
| Serial | Dᵥ5 | Single-layer | of copper | of | Types of | VED | (500 | DCR |
| number | 0/μm | thickness/μm | foil/μm | primer/μm | primer | (Wh/L) | cycles) | (mΩ) |
| Example | 10 | 82 | 13 | 0 | Non | 730 | 82.5 | 98 |
| 16 | | | | | | | | |
| Example | 10 | 30 | 12 | 2.0 | Carbon | 740 | 88.1 | 80 |
| 24 | | | | | black | | | |
| Example | 10 | 40 | 10 | 1.5 | Carbon | 743 | 87.9 | 82 |
| 25 | | | | | black | | | |
| Example | 10 | 50 | 8 | 1.3 | Carbon | 750 | 87.7 | 85 |
| 26 | | | | | black | | | |
| Example | 10 | 60 | 6 | 1.0 | Carbon | 755 | 87.5 | 87 |
| 27 | | | | | black | | | |
| Example | 10 | 70 | 5 | 0.8 | Carbon | 760 | 87.3 | 89 |
| 28 | | | | | black | | | |
| Example | 10 | 80 | 4 | 0.5 | Carbon | 770 | 87.1 | 93 |
| 29 | | | | | black | | | |
| Example | 10 | 60 | 6 | 1.0 | Carbon | 756 | 87.2 | 83 |
| 30 | | | | | fiber | | | |
| Example | 10 | 60 | 6 | 1.0 | Carbon | 757 | 87.1 | 80 |
| 31 | | | | | nanotube | | | |
| Example | 10 | 60 | 6 | 1.0 | Graphene | 758 | 87.0 | 78 |
| 32 | | | | | | | | |
| Example | 10 | 25 | 3 | 3.0 | Carbon | 700 | 80.0 | 100 |
| 33 | | | | | black | | | |

As shown in Table 3, based on example 16 of Table 2, an effect of thickness data of the negative electrode active material layer on the volumetric energy density (VED), the cycling capacity retention rate, and the DCR is further investigated.

According to examples 24 to 29, as a single layer thickness of the lithium ion negative electrode active material layer gradually increases, the thickness of the copper foil gradually decreases, the thickness of the primer layer gradually decreases, the volumetric energy density of the lithium-ion battery gradually increases, the cycling performance gradually decreases, and the DCR gradually increases. This happens because as the thickness of the negative electrode active material layer increases, a percentage of active substances per unit volume increases. With the same volume, higher capacity can be achieved, and both the thickness of the copper foil and the thickness of the primer layer gradually decrease, which is also conducive to achieving higher volumetric energy density. The cycling performance decreases because as the thickness of the negative electrode active material layer increases, infiltration of the electrolyte deteriorates, and side reaction products caused by polarization accumulate, manifested as deterioration of both the cycling and the kinetics.

According to examples 30 to 32, different nano primers are used and corresponds to different energy density, cycling performance, and kinetic performance. This is significantly related to characteristics and addition amount of the nano primer.

According to example 33, when the thickness of the negative electrode active material layer is reduced to 25 μm, the thickness of the copper foil is reduced to 3 μm, and the thickness of the primer layer is reduced to 3 μm, there is a significant impact on processing performance. An appearance of the negative electrode active material layer has many protrusions, and after a battery cell is made, the volumetric energy density of the battery cell is low and cycling performance and kinetic performance is also poor. Therefore, it is necessary to use an appropriate thickness of the negative electrode active material layer, as well as an appropriate thickness of the primer layer and the copper foil, to achieve good electrochemical performance.

Finally, it should be noted that the above examples are merely intended for describing the technical solutions of this application, but not for limiting this application. Although this application is described in detail with reference to the above examples, persons with ordinary skill in the art should understand that they may still make modifications to the technical solutions described in the above embodiments or make equivalent replacements to some or all technical features thereof. These modifications or replacements do not make the essence of the corresponding technical solutions depart from the scope of the technical solutions of the examples of this application, and should be all fall within the scope of the claims and this specification of this application. In particular, various technical features mentioned in the examples can be combined in any manner provided that there is no structural conflict. This application is not limited to the specific embodiments disclosed in this specification, but includes all technical solutions falling within the scope of the claims.

1. A negative electrode plate, comprising:
a negative electrode current collector; and
a negative electrode active material layer disposed on at least one side of the negative electrode current collector, wherein the negative electrode active material contains negative electrode active substance particles;
wherein the negative electrode active material layer comprises
a surface layer with an ID₁/IG₁ value of A, and
a substrate layer with an ID₂/IG₂ value of B;
the substrate layer is located between the negative electrode current collector and the surface layer; wherein,
0.55≤A≤0.78,
0.78≤B≤0.96, and
0.60≤A/B≤1.0; wherein,
ID₁ is a peak intensity of a scatter peak of a negative electrode active substance in the surface layer at a Raman shift of 1328-1359 cm⁻¹ in the Raman spectrum;
IG₁ is a peak intensity of the scatter peak of the negative electrode active substance in the surface layer at a Raman shift of 1578-1585 cm⁻¹ in the Raman spectrum;
ID₂ is a peak intensity of the scatter peak of the negative electrode active substance in the substrate layer at a Raman shift of 1328-1359 cm⁻¹ in the Raman spectrum; and
IG₂ is a peak intensity of the scatter peak of the negative electrode active substance in the substrate layer at a Raman shift of 1578-1585 cm⁻¹ in the Raman spectrum.

2. The negative electrode plate according to claim 1, wherein 0.70≤A/B≤0.96.

3. The negative electrode plate according to claim 2, wherein 0.75≤A/B≤0.85.

4. The negative electrode plate according to claim 1, wherein a thickness of the surface layer ranges from 5 μm to 20 μm.

5. The negative electrode plate according to claim 1, wherein a thickness of the negative electrode active material layer ranges from 30 μm to 160 μm.

6. The negative electrode plate according to claim 1, wherein the negative electrode plate satisfies at least one of the following conditions:
(1) the maximum particle size of the negative electrode active substance particles is ≤55 μm;
(2) Dᵥ50 of the negative electrode active substance particles ranges from 5 μm to 15 μm; or
(3) a ratio Dᵥ90/Dᵥ10 of the negative electrode active substance particles ranges from 1.2 to 3.2.

7. The negative electrode plate according to claim 1, wherein the negative electrode active substance comprises one or more selected from the group consisting of natural graphite, artificial graphite, mesophase carbon microbeads, hard carbon, soft carbon, and a carbon-silicon composite.

8. The negative electrode plate according to claim 1, wherein,
the negative electrode plate further comprises a primer layer disposed between the negative electrode current collector and the substrate layer; and
the primer layer comprises a conductive agent.

9. The negative electrode plate according to claim 8, wherein the conductive agent comprises one or more selected from the group consisting of conductive carbon black, carbon nanotubes, carbon fibers, and graphene.

10. The negative electrode plate according to claim 8, wherein a thickness of the primer layer ranges from 0.01 μm to 2 μm.

11. The negative electrode plate according to claim 6, wherein,
the negative electrode plate further comprises a primer layer disposed between the negative electrode current collector and the substrate layer; and
the primer layer comprises a conductive agent.

12. The negative electrode plate according to claim 7, wherein,
the negative electrode plate further comprises a primer layer disposed between the negative electrode current collector and the substrate layer; and
the primer layer comprises a conductive agent.

13. A secondary battery, comprising a negative electrode plate, the negative electrode plate comprises
a negative electrode current collector; and
a negative electrode active material layer disposed on at least one side of the negative electrode current collector, wherein the negative electrode active material contains negative electrode active substance particles;
wherein the negative electrode active material layer comprises
a surface layer with an ID₁/IG₁ value of A, and
a substrate layer with an ID₂/IG₂ value of B;
the substrate layer is located between the negative electrode current collector and the surface layer; wherein,
0.55≤A≤0.78,
0.78≤B≤0.96, and
0.60≤A/B≤1.0; wherein,
ID₁ is a peak intensity of a scatter peak of a negative electrode active substance in the surface layer at a Raman shift of 1328-1359 cm⁻¹ in the Raman spectrum;
IG₁ is a peak intensity of the scatter peak of the negative electrode active substance in the surface layer at a Raman shift of 1578-1585 cm⁻¹ in the Raman spectrum;
ID₂ is a peak intensity of the scatter peak of the negative electrode active substance in the substrate layer at a Raman shift of 1328-1359 cm⁻¹ in the Raman spectrum; and
IG₂ is a peak intensity of the scatter peak of the negative electrode active substance in the substrate layer at a Raman shift of 1578-1585 cm⁻¹ in the Raman spectrum.

14. The secondary battery according to claim 13, wherein a thickness of the surface layer ranges from 5 μm to 20 μm.

15. The secondary battery according to claim 13, wherein a thickness of the negative electrode active material layer ranges from 30 μm to 160 μm.

16. The secondary battery according to claim 13, wherein the negative electrode plate satisfies at least one of the following conditions:
(1) the maximum particle size of the negative electrode active substance particles is ≤55 μm;
(2) Dᵥ50 of the negative electrode active substance particles ranges from 5 μm to 15 μm; or
(3) a ratio Dᵥ90/Dᵥ10 of the negative electrode active substance particles ranges from 1.2 to 3.2.

17. The secondary battery according to claim 13, wherein the negative electrode active substance comprises one or more selected from the group consisting of natural graphite, artificial graphite, mesophase carbon microbeads, hard carbon, soft carbon, and a carbon-silicon composite.

18. The secondary battery according to claim 13, wherein,
the negative electrode plate further comprises a primer layer disposed between the negative electrode current collector and the substrate layer; and
the primer layer comprises a conductive agent.

19. An electric apparatus, comprising a secondary battery, the secondary battery comprises a negative electrode plate, and the negative electrode plate comprises
a negative electrode current collector; and
a negative electrode active material layer disposed on at least one side of the negative electrode current collector; wherein the negative electrode active material contains negative electrode active substance particles;
wherein the negative electrode active material layer comprises
a surface layer with an ID₁/IG₁ value of A, and
a substrate layer with an ID₂/IG₂ value of B;
the substrate layer is located between the negative electrode current collector and the surface layer; wherein,
0.55≤A≤0.78,
0.78≤B≤0.96, and
0.60≤A/B≤1.0; wherein,
ID₁ is a peak intensity of a scatter peak of a negative electrode active substance in the surface layer at a Raman shift of 1328-1359 cm⁻¹ in the Raman spectrum;
IG₁ is a peak intensity of the scatter peak of the negative electrode active substance in the surface layer at a Raman shift of 1578-1585 cm⁻¹ in the Raman spectrum;
ID₂ is a peak intensity of the scatter peak of the negative electrode active substance in the substrate layer at a Raman shift of 1328-1359 cm⁻¹ in the Raman spectrum; and
IG₂ is a peak intensity of the scatter peak of the negative electrode active substance in the substrate layer at a Raman shift of 1578-1585 cm⁻¹ in the Raman spectrum.

20. The electric apparatus according to claim 19, wherein a thickness of the surface layer ranges from 5 μm to 20 μm.
